(19) United States
(12) Patent Application Publication
(10) Pub. No.: US 2007/0059085 A1
(43) Pub. Date: Mar. 15, 2007

(54) Printer

(75) Inventors: Takahito Maruyama, Fukushima-ken (JP); Yoshibumi Abe, Fukushima-ken (JP); Zenko Motoki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/505,657

(22) Filed: Aug. 16, 2006

(30) Foreign Application Priority Data
Aug. 31, 2005 (JP) 2005-251885

(51) Int. Cl. B41J 13/10

(52) U.S. Cl. 400/625

(57) ABSTRACT

A printer is disclosed. The printer includes a platen roller that is rotated as a main driving source. A driving force transmitted to the platen roller is further transmitted to first and second feeding rollers so that the first and second feeding rollers rotate such as to follow the platen roller.

This application claims the benefit of Japanese Patent Application No. 2005-251885 filed on Aug. 31, 2005, which is hereby incorporated by reference.

### BACKGROUND

1. Field

A printer is provided. In a preferred embodiment, the printer includes a sheet feeding mechanism in which a recording sheet is fed by being pressed and guided by a feeding roller and a pressure roller.

2. Related Art

As shown in FIG. 4., Japanese Unexamined Patent Application Publication No. 8-72335 discloses a printer that prints on a recording sheet 37 by thermally transferring ink of an ink ribbon 31 with a thermal head 34 that is moved down to press the ink ribbon 31 against the recording sheet 37.

When printing is conducted by the above-described printer, the recording sheet is fed downstream from the left side to the right side in the figure by a sheet feeding mechanism that is constituted by, for example, a first feeding roller 38, and a second feeding roller 39. The first feeding roller 38 and the second feeding roller 39 are respectively disposed on the left and right sides of the thermal head 34. A first pressure roller 38a and a second pressure roller 39a are respectively disposed on the upper sides of the first feeding roller 38 and the second feeding roller 39, and are elastically urged against the first feeding roller 38 and the second feeding roller 39. The first and second feeding rollers 38 and 39 and the first and second pressure rollers 38a and 39a can nip the recording sheet 37 therebetween. By the clockwise or counterclockwise rotation of the feeding rollers 38 and 39, the recording sheet 37 can be fed upstream and downstream.

A platen roller 40 is disposed such as to oppose a lower side of the thermal head 34, and the thermal head 34 and the platen roller 40 can nip the recording sheet 37 therebetween.

In the above-described printer, the first feeding roller 38 and the second feeding roller 39 are rotated by sequentially transmitting a driving force of an unshown driving motor (first driving motor) disposed below the first feeding roller 38. The driving force of the first driving motor is first transmitted to one end of a rotation shaft of the first feeding roller 38 via an unshown timing belt. The driving force is then transmitted to the second feeding roller 39 via a timing pulley disposed at the other end of the first feeding roller 38 to which the driving force has been transmitted, thus rotating the second feeding roller 39.

The platen roller 40 is independently rotated by a driving force of an unshown driving motor (second driving motor) disposed below the platen roller 40.

When color printing is performed by the printer, a front end of the recording sheet 37 is located with a sheet sensor 41 in a first-color printing operation (first printing operation). The recording sheet 37 is nipped between the first feeding roller 38 and the first pressure roller 38a. Subsequently, when the recording sheet 37 is fed downstream by the first feeding roller 38, the front end of the recording sheet 37 is nipped between the thermal head 34 placed in a down position and the platen roller 40. The recording sheet 37 is nipped at two positions between the first feeding roller 38 and the first pressure roller 38a and between the thermal head 34 and the platen roller 40.

The recording sheet 37 is fed downstream while being still nipped between the platen roller 40 and the thermal head 34, and thermal transfer of first color ink is started from the front end of the recording sheet 37. During thermal transfer, the recording sheet 37 is nipped at three positions between the first feeding roller 38 and the first pressure roller 38a, between the thermal head 34 and the platen roller 40, and between the second feeding roller 39 and the second pressure roller 39a.

When a first color image is printed on the recording sheet 37 and the first printing operation is completed, the thermal head 34 is brought into an up state against the urging force of a spring 36. The printed recording sheet 37 nipped between the second feeding roller 39 and the second pressure roller 39a is fed back to the left upstream side in the figure through between the thermal head 34 and the platen roller 40 by the counterclockwise rotation of the second feeding roller 39.

When the recording sheet 37 is fed back, a rear end thereof tilts a contactor 41b of the sheet sensor 41 to the left. The recording sheet 37 is nipped between the second feeding roller 39 and the second pressure roller 39a, and is further fed back by the counterclockwise rotation of the first feeding roller 38.

When the contactor 41b of the sheet sensor 41 separates from the front end of the recording sheet 37 and is placed in an upright position, the front end of the recording sheet 37 is located again, and the rotation of the first feeding roller 38 is stopped. The same printing operation as the first printing operation is performed again as a second printing operation to print a second color image on the first color image.

Third and fourth color images are superimposed on the second color image by performing similar processes as third and fourth printing operations, so that a desired color image can be printed on the recording sheet 37.

In the above-described sheet feeding mechanism, however, the driving force is first transmitted from the first driving motor to the first feeding roller 38, and is then transmitted from the first feeding roller 38, to which the driving force has been transmitted, to the second feeding roller 39 via timing pulleys or the like. Normally, there is backlash at a meshed portion between the timing pulleys, gears, or the like for transmitting the driving force to the members. The backlash of the gears or the like increases as the total number of timing pulleys or gears provided between the driving members, such as the motors, and the driven members, such as the feeding rollers, increases. As a result, the sheet is sometimes not fed uniformly and precisely. This may cause printing failure of misalignment of different superimposed color inks of the ink ribbon 31 particularly during color printing.

In addition, since the first driving motor for driving the first feeding roller and so on and the second driving motor for driving the platen roller are separately provided, it is impossible to meet the demand to reduce the cost.

### SUMMARY

A printer according to a preferred embodiment includes a first feeding roller and a second feeding roller. A platen roller is disposed between the first and second feeding rollers. A driving member transmits a driving force to the platen roller so as to rotate the platen roller. A thermal head opposes the platen roller. A transmission unit transmits the driving force from the platen roller to the first and second feeding rollers. A recording sheet is fed by the first and second feeding rollers that are rotated by the driving force transmitted by the transmission unit.

The first and second feeding rollers are rotated such as to follow the platen roller by further transmitting the driving force, which has been transmitted to the platen roller, to the first and second feeding rollers. Consequently, the total number of gears, for example, provided between the driving member and the members to be driven can be reduced, and backlash of the gears can be reduced. Since the number of the gears provided between the first feeding roller and the platen roller can be made equal to the number of the gears provided between the second feeding roller and the platen roller, the amount of backlash of the gears can be made equal.

In a preferred embodiment, the transmission unit includes driving-force transmission gears provided between the first feeding roller and the platen roller and between the second feeding roller and the platen roller, and the first and second feeding rollers are rotated by the driving-force transmission gears in the same direction as a rotating direction of the platen roller. The driving force transmitted to the platen roller can be reliably transmitted to the first and second feeding rollers.

In a preferred embodiment, the printer further includes a first pressure roller that is in pressing contact with the first feeding roller and rotates such as to follow the first feeding roller. The recording sheet can be nipped between the first feeding roller and the first pressure roller, and therefore, sheet feeding can be reliably performed.

In another preferred embodiment, the printer further includes a second pressure roller that is in pressing contact with the second feeding roller and rotates such as to follow the second feeding roller. The recording sheet can be nipped between the second feeding roller and the second pressure roller, and therefore, sheet feeding can be performed more reliably.

In the preferred embodiment, non-uniform sheet feeding is rarely caused, and reliable sheet feeding is possible. As a result, even when color printing is performed to print different colors one on another, color misalignment rarely occurs, and printing quality can be enhanced.

Therefore, a printer that includes a sheet feeding mechanism having a simple structure, that can achieve high printing quality with little non-uniform feeding, and that can reduce the cost is provided.

### DRAWINGS

FIG. 1 is a schematic perspective view of a printing section in a printer according to a preferred embodiment;

FIG. 2 is a perspective view of a sheet feeding mechanism;

FIG. 3 is a side view of the sheet feeding mechanism; and

FIG. 4 is a schematic view of a printing section in a known printer.

### DESCRIPTION OF THE PREFERRED EMBODIMENTS

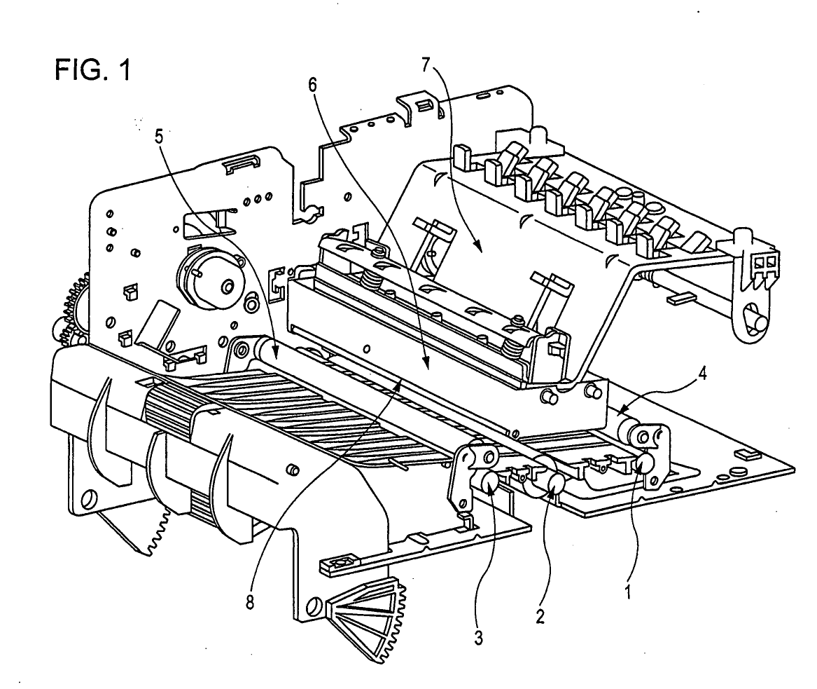

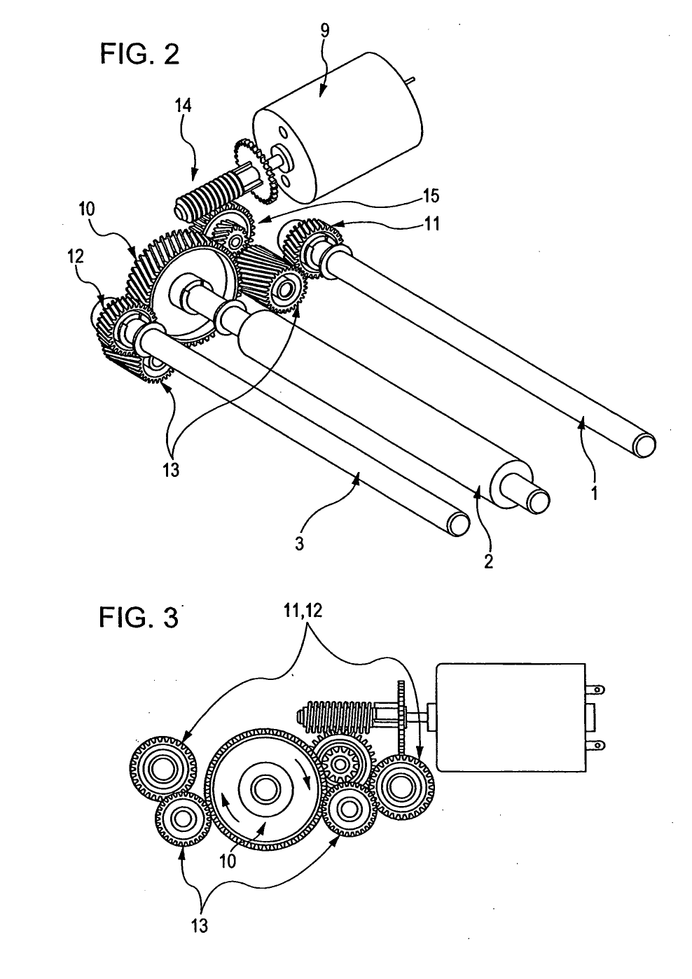

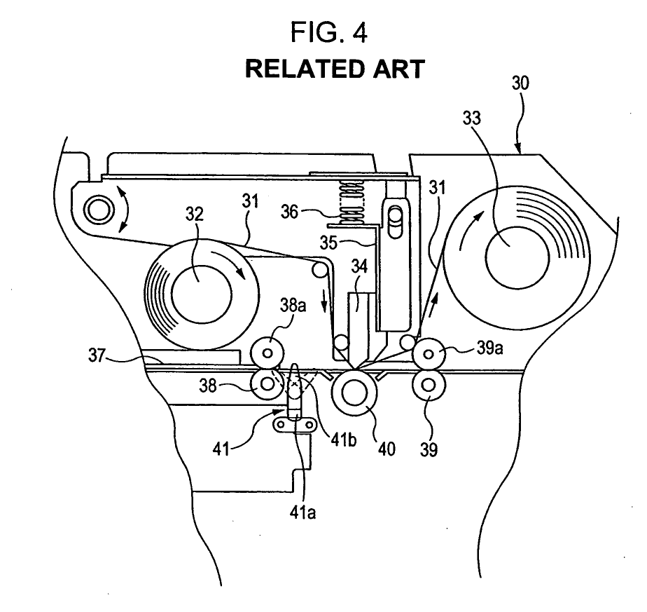

A thermal transfer printer will be described below as a printer according to a preferred with reference to FIGS. 1 to 3. FIG. 1 is a perspective view of a printing section in the thermal transfer printer, FIG. 2 is a perspective view of a sheet feeding mechanism in the printer, and FIG. 3 is a side view of the sheet feeding mechanism shown in FIG. 2.

The thermal transfer printer shown in FIG. 1 mainly includes a first feeding roller 1, a platen roller 2, a second feeding roller 3, a thermal head (not shown), and a head unit 7 provided with a head guide unit 6 under which the thermal head is mounted.

The first feeding roller 1 can feed a recording sheet, which is supplied from a sheet supply cassette (not shown), upstream or downstream therefrom in a feeding direction of the recording sheet, and can be rotated in both clockwise and counterclockwise directions by the rotation transmitted from the platen roller 2.

The sheet supply cassette stores a plurality of recording sheets having a predetermined size, and is disposed on the right side of the first feeding roller 1 in FIG. 1.

The platen roller 2 is disposed on the downstream side of the first feeding roller 1, and can be rotated in both the clockwise and counterclockwise directions by a driving force transmitted from a driving motor 9 that will be described below.

The second feeding roller 3 is disposed on the downstream side of the platen roller 2. The second feeding roller 3 feeds a recording sheet, which is conveyed by the first feeding roller 1 or the platen roller 2, upstream or downstream therefrom, and can be rotated in both the clockwise and counterclockwise directions by the rotation transmitted from the platen roller 2.

When a recording sheet supplied from the sheet supply cassette is conveyed to the platen roller 2 by the first feeding roller 1, the thermal head is moved down to press the recording sheet against the platen roller 2 with an ink ribbon disposed therebetween, and the platen roller 2 is rotated counterclockwise, so that the recording sheet on which a predetermined image is printed can be conveyed to the left downstream side of the platen roller 2 in the figure.

The thermal head that thermally transfers ink from the ink ribbon onto the recording sheet is disposed on a lower side of the head unit 7 that faces the platen roller 2, and a plurality of heating elements are arranged in a direction orthogonal to the feeding direction of the recording sheet.

During printing, the thermal head is moved down, and the heating elements are selectively caused to generate heat according to image signals transmitted from a control unit, so that the ink of the ink ribbon is selectively and thermally transferred to print a desired image on the recording sheet. When the printing operation is completed (including a case in which a part of the printing operation is completed), the thermal head is moved up and separates from the platen roller 2. The thermal head is moved up and down by upward and downward movements of the head unit 7.

A first pressure roller 4 is disposed such as to oppose an upper side of the first feeding roller 1. The first pressure roller 4 is elastically biased in pressing contact with the first feeding roller 1, and can rotate such as to follow the first feeding roller 1. A recording sheet can be nipped between the first feeding roller 1 and the first pressure roller 4.

A second pressure roller 5 is disposed such as to oppose an upper side of the second feeding roller 2. The second pressure roller 5 is elastically biased in pressing contact with the second feeding roller 3, and can rotate such as to follow the second feeding roller 3. A recording sheet can be nipped between the second feeding roller 3 and the second pressure roller 5.

A driving-force transmission unit in a sheet feeding mechanism constituted by the first feeding roller 1, the platen roller 2, the second feeding roller 3, and so on will now be described with reference to FIGS. 2 and 3.

A main driving gear 10 is rotatably supported at one end of the platen roller 2. The main driving gear 10 is connected to a driving motor 9 serving as a driving member for rotating the main driving gear 10 via a driving gear 14 and a conversion gear 15. For example, the driving motor 9 can be formed of a stepping motor.

A pair of idle gears 13 are meshed with the right and left sides of the main driving gear 10, a first driven gear 11 is meshed with the right idle gear 13, and a second driven gear 12 is meshed with the left idle gear 13. When a rotating force of the main driving gear 10 rotated by the driving motor 9 is transmitted from the idle gears 13 to the first and second feeding rollers 1 and 3 via the first and second driven gears 11 and 12, the first and second feeding rollers 1 and 3 are rotated in the same direction as the rotating direction of the platen roller 2.

Feeding of the recording sheet during printing will now be described with reference to FIGS. 1 to 3.

Recording sheets are separated one by one from the sheet supply cassette by a pickup roller. One separated recording sheet is fed to the left downstream side in FIG. 1, and a front end of the recording sheet is nipped between the first feeding roller 1 and the first pressure roller 4. The first feeding roller 1 is rotated counterclockwise by a driving force transmitted from the driving motor 9 via the main driving gear 10, and the recording sheet is thereby fed downstream.

When the recording sheet is fed downstream, since the platen roller 2 is rotated by the driving motor 9, the first feeding roller 1, the platen roller 2, and the second feeding roller 3 are rotated in the same counterclockwise direction.

When the recording sheet is fed downstream by the first feeding roller 1 and the first pressure roller 4 and a front end of the recording sheet reaches a predetermined position, it is detected by a sheet sensor (not shown), and is located. After being located, the front end of the recording sheet is nipped with the ink ribbon between the thermal head placed in a down state, and the platen roller 2.

Upon locating the front end of the recording sheet, a plurality of heating elements in the thermal head are selectively caused to generate heat according to image information, and a first printing operation is started so that a first color ink of the ink ribbon is thermally transferred onto the recording sheet, which is being conveyed downstream, from the front end of the recording sheet. At this printing start position, the recording sheet is nipped at two positions, for example, between the first feeding roller 1 and the first pressure roller 4 and between the thermal head and the platen roller 2, and is fed downstream in this state.

When printing further proceeds, the recording sheet is nipped at three positions, for example, at the above-described two positions and a position between the second feeding roller 3 and the second pressure roller 5.

During the first printing operation, a rear end of the recording sheet comes out from between the first feeding roller 1 and the first pressure roller 4 that are in pressing contact with each other, and the recording sheet is further fed downstream. The recording sheet is nipped at two positions between the thermal head and the platen roller 2 and between the second feeding roller 3 and the second pressure roller 5. When the rear end of the recording sheet comes out of the pressing contact with the heating section of the thermal head, printing of a first color image on the recording sheet is completed.

When the rear end of the recording sheet is detected by the sheet sensor, the thermal head is moved up in response to the detection, the driving motor 9 is reversed, and the platen roller 2, the first feeding roller 1, and the second feeding roller 3 are reversed in the clockwise direction. In this reverse rotation, the recording sheet, which has been subjected to the first printing operation, is fed back to the right upstream side in FIG. 1, the front end of the recording sheet is returned to the sheet sensor, and the recording sheet having the first color image printed thereon is nipped again between the first feeding roller 1 and the first pressure roller 4.

When the recording sheet is fed back, the platen roller 2 is also rotated by the driving motor 9 so that the first and second feeding rollers 1 and 3 rotate such as to follow the platen roller 2. Therefore, it is possible to reduce the backlash of the first and second feeding rollers 1 and 3.

In color printing, when the front end of the recording sheet fed back upstream is detected again by the sheet sensor, the upstream feeding is completed, and the thermal head is moved down again. The first feeding roller 1, the platen roller 2, and the second feeding roller 3 are rotated again counterclockwise, thereby conveying the recording sheet downstream.

When the recording sheet nipped between the first feeding roller 1 and the first pressure roller 4 and between the platen roller 2 and the thermal head is fed downstream, a second printing operation is performed to print a second color image on the first color image printed in the first printing operation.

Subsequently, third and fourth color images are superimposed on the second color image by repeating the same operation as third and fourth printing operations, so that a desired color image can be printed on the recording sheet.

While the first and second feeding rollers 1 and 3 are simultaneously rotated when the platen roller 2 is rotated by the driving of the driving motor 9 in the above-described embodiment, the recording sheet may be fed forward and backward by alternately rotating the first and second feeding rollers 1 and 3 with a driving-force switching means (not shown).

What is claimed is:

1. A printer comprising:
a first feeding roller and a second feeding roller;
a platen roller disposed between the first and second feeding rollers;
a driving member that transmits a driving force to the platen roller so as to rotate the platen roller;
a thermal head opposing the platen roller; and
a transmission unit that transmits the driving force from the platen roller to the first and second feeding rollers,
wherein a recording sheet is fed by the first and second feeding rollers that are rotated by the driving force transmitted by the transmission unit.

2. The printer according to claim 1, wherein the transmission unit includes driving-force transmission gears provided between the first feeding roller and the platen roller and between the second feeding roller and the platen roller, and
wherein the first and second feeding rollers are rotated by the driving-force transmission gears in the same direction as a rotating direction of the platen roller.

3. The printer according to claim 1, further comprising:
a first pressure roller that is in pressing contact with the first feeding roller and rotates such as to follow the first feeding roller.

4. The printer according to claim 1, further comprising:
a second pressure roller that is in pressing contact with the second feeding roller and rotates such as to follow the second feeding roller.
